(19) United States
(12) Patent Application Publication
(10) Pub. No.: US 2025/0343444 A1
(43) Pub. Date: Nov. 6, 2025

(54) WIRELESS POWER TRANSMISSION METHOD AND WIRELESS POWER TRANSMISSION DEVICE

(71) Applicant: Panasonic Holdings Corporation, Osaka (JP)

(72) Inventors: Yuki TANAKA, Tokyo (JP); Yoshio KOYANAGI, Kanagawa (JP); Hiroshi SATO, Kanagawa (JP); Hikaru HAMASE, Osaka (JP)

(21) Appl. No.: 19/270,854

(22) Filed: Jul. 16, 2025

Related U.S. Application Data
(63) Continuation of application No. PCT/JP2023/042271, filed on Nov. 24, 2023.

(30) Foreign Application Priority Data
Jan. 31, 2023 (JP) 2023-013126

(51) Int. Cl. H02J 50/20; H02J 50/70

(52) U.S. Cl. CPC H02J 50/20; H02J 50/70

(57) ABSTRACT

With regards to wireless power transmission, the present invention enables coexistence with wireless communication and enables improvement in power feeding efficiency. This wireless power transmission method for transferring electric power by emitting a radio wave into space involves emitting a radio wave into space, when a state where another radio wave has not been transferred in the space continues for at least a first period, after standing by for a second period.

### TECHNICAL FIELD

The present disclosure relates to a wireless power transmission method and a wireless power transmission device.

### BACKGROUND ART

As described in Non Patent Literature 1, a space transmission type wireless power transmission system that transmits power using radio waves has been studied.

### CITATION LIST

### Non-Patent Literature

Non Patent Literature 1: Information and Communication Council, Information Communication Technology Subcommittee, Committee on Land Radio Communications, Spatial Wireless Communication Committee, Work Group ON Space Transmission Type Wireless Power Transmission System, Summary of the Report (Draft), [online], May 2020, [Search on Jan. 13, 2023], Internet <URL: https://www.soumu.go.jp/main_content/000694293.pdf>

Non Patent Literature 2: ARIB STD-T107 “Specified low power radio station 920 MHz band mobile object identification radio equipment”

### PATENT LITERATURE

Patent Literature 1: JP2006-60310A

### SUMMARY OF INVENTION

Wireless power transmission in which power is transmitted using radio waves is required to coexist with existing systems such as wireless communication for transmitting or receiving data and radio frequency identification (RFID), and to improve power supply efficiency, but the study in the related art is insufficient.

An object of the present disclosure relates to wireless power transmission, and is to provide a technique for realizing coexistence with wireless communication and improvement in power supply efficiency.

A wireless power transmission method according to an aspect of the present disclosure is a wireless power transmission method for transmitting power by transmitting a radio wave to a space, the wireless power transmission method including transmitting the radio wave to the space after waiting for a second period when a state in which another radio wave is not transmitted in the space continues for at least a first period.

A wireless power transmission device according to an aspect of the present disclosure is a wireless power transmission device that transmits power by transmitting a radio wave to a space, the wireless power transmission device including: a monitoring unit configured to monitor whether another radio wave is transmitted in the space; a control unit configured to determine transmission of the radio wave after waiting for a second period when a state in which the other radio wave is not transmitted continues for at least a first period; and a transmission unit configured to transmit the radio wave from a predetermined antenna based on determination of the control unit.

These comprehensive or specific aspects may be implemented by a system, a device, a method, an integrated circuit, a computer program, a recording medium, or any combination of the system, the device, the method, the integrated circuit, the computer program, and the recording medium.

According to the present disclosure, regarding wireless power transmission, it is possible to realize coexistence with wireless communication and improvement in power supply efficiency.

### BRIEF DESCRIPTION OF DRAWINGS

FIG. 1 is a block diagram illustrating an example of a wireless power supply system according to the present embodiment;

FIG. 2 is a diagram illustrating carrier sense of the related art;

FIG. 3 is a block diagram illustrating a configuration example of the wireless power transmission device according to the present embodiment;

FIG. 4 is a diagram illustrating state transition related to a wireless power transmission method according to the present embodiment;

FIG. 5 is a flowchart illustrating an example of the wireless power transmission method according to the present embodiment;

FIG. 6 is a diagram illustrating a first example of an operation of a wireless power supply system that performs the carrier sense of the related art;

FIG. 7 is a diagram illustrating a first example of an operation of the wireless power supply system that performs the wireless power transmission method of the present embodiment;

FIG. 8 is a diagram illustrating a second example of the operation of the wireless power supply system that performs the carrier sense of the related art; and

FIG. 9 is a diagram illustrating a second example of the operation of the wireless power supply system that performs the wireless power transmission method of the present embodiment.

### DESCRIPTION OF EMBODIMENTS

Hereinafter, an embodiment of the present disclosure will be described in detail with reference to the drawings as appropriate. However, unnecessarily detailed description may be omitted. For example, detailed description of already well-known matters and redundant description of substantially the same configuration may be omitted. This is to avoid unnecessary redundancy of the following description and to facilitate understanding of those skilled in the art. The accompanying drawings and the following description are provided for those skilled in the art to sufficiently understand the present disclosure, which are not intended to limit the subject matter described in the claims.

### Present Embodiment

### <Wireless Power Supply System>

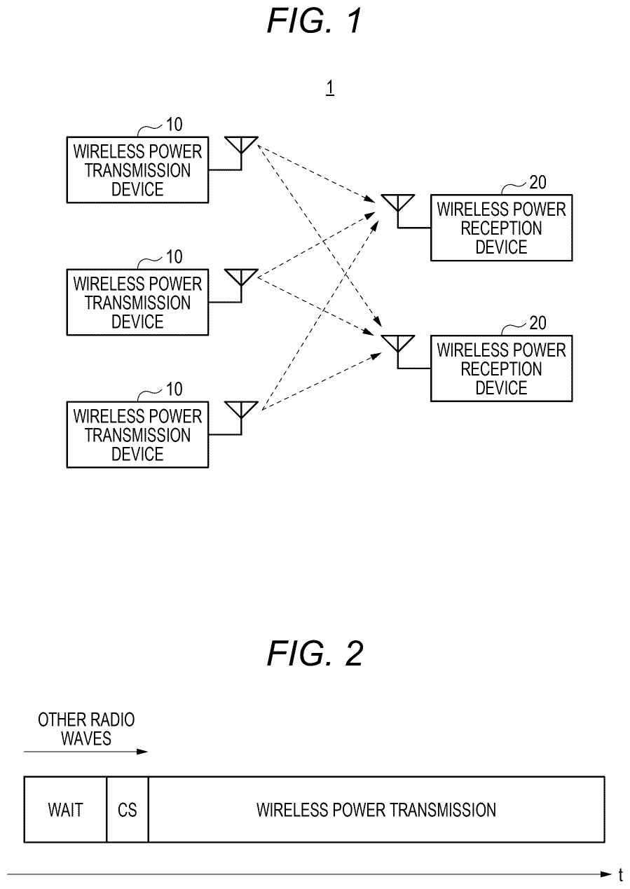

FIG. 1 is a block diagram illustrating an example of a wireless power supply system 1 according to the present embodiment.

The wireless power supply system 1 is a system that transmits power using radio waves, and includes at least one wireless power transmission device 10 and at least one wireless power reception device 20 as illustrated in FIG. 1.

The wireless power transmission device 10 transmits radio waves for transmitting power to the wireless power reception device 20. The wireless power reception device 20 obtains power by receiving the radio waves transmitted from the wireless power transmission device 10. Hereinafter, the wireless power transmission device 10 transmitting a radio wave for transmitting power may be referred to as wireless power transmission, and the wireless power reception device 20 receiving the radio wave transmitted from the wireless power transmission device 10 may be referred to as wireless power reception.

The wireless power transmission device 10 may be a device having only a wireless power transmission function, or may be a device having a communication function such as an RFID interrogator. The wireless power reception device 20 may be a sensor terminal, a display terminal, an actuator, a charger, a power receiver, a light, a speaker, or a combination thereof.

The radio wave for power transmission may be a microwave. A frequency band (carrier) of the radio wave for power transmission may be a 920 MHz band, a 2.4 GHz band, or a 5.7 GHz band. The wireless power transmission device 10 and the wireless power reception device 20 may be set to use a common frequency band.

When wireless power supply is performed using microwaves, it is conceivable to perform carrier sense to avoid interference in order to reduce an influence on a wireless communication system present in the vicinity of the wireless power supply system 1. FIG. 2 is a diagram illustrating carrier sense of the related art. In FIG. 2, a horizontal axis t represents elapsed time.

In a wireless power supply method of the related art, as illustrated in FIG. 2, after waiting for a predetermined period, the carrier sense (CS) for confirming whether another radio wave is transmitted in a channel for performing wireless power transmission is executed for a predetermined period, and when it is confirmed that the other radio wave is not transmitted in the carrier sense, wireless power transmission is started (see Non Patent Literature 2).

However, in the wireless power supply method of the related art, in a case where a plurality of wireless power transmission devices are present in the vicinity, while a certain wireless power transmission device is performing wireless power transmission, the other wireless power transmission device continues the carrier sense, and thus wireless power transmission cannot be performed. That is, unlike wireless communication for transmitting or receiving data, although wireless power supply systems that transmit energy do not have a disadvantage due to interference of a plurality of waves, in the wireless power supply method of the related art, while a certain wireless power transmission device performs wireless power transmission, the other wireless power transmission device does not perform wireless power transmission, which leads to a decrease in the power supply efficiency in the entire wireless power supply system.

Since wireless power supply transmits energy, a channel tends to be used for a longer time than wireless communication. Therefore, in the case where there are a plurality of wireless power transmission devices, after a certain wireless power transmission device ends wireless power transmission, the other wireless power transmission device performs wireless power transmission without delay, and a ratio of a period during which the wireless communication system can use the channel becomes extremely small. In order to avoid this, it is conceivable to make the period of the carrier sense of the wireless power transmission device longer than the period of the carrier sense of the wireless communication system, but in this case, a probability that the wireless power transmission device can use the channel decreases, and the power supply efficiency decreases.

In the related art disclosed in Patent Literature 1, a plurality of RFID readers are operated in synchronization using a synchronization signal having a frequency other than a frequency to be used by the own system. However, this technique cannot operate in cooperation with an unknown wireless communication system using the same frequency band, and causes interference with each other. Further, since a frequency for a synchronization signal is required in addition to the frequency used by the own system for wireless communication, there is a problem that the occupied frequency bandwidth increases.

Therefore, in the present embodiment, a technique for realizing the improvement in the power supply efficiency using a single frequency while considering the influence on the wireless communication system will be described.

### <Configuration of Wireless Power Transmission Device>

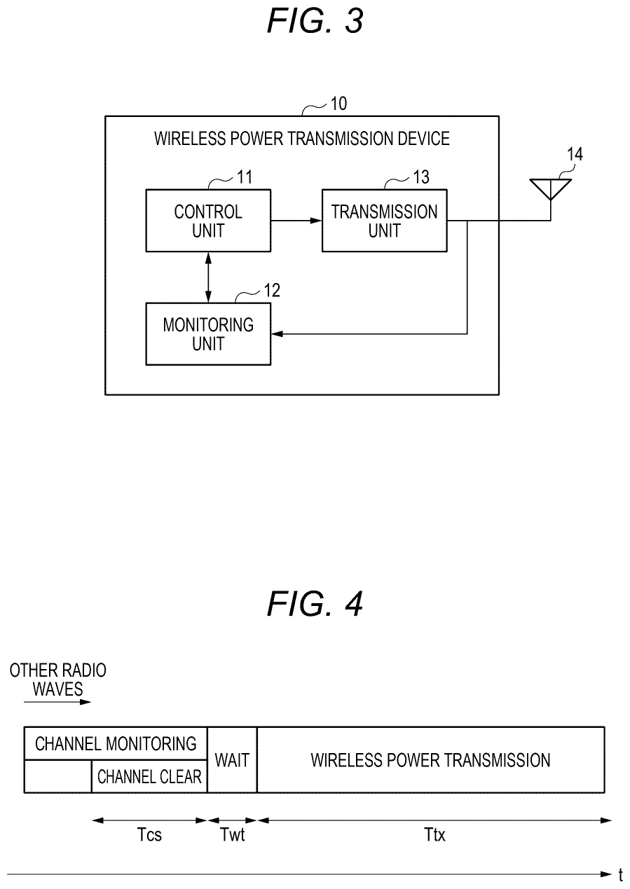

FIG. 3 is a block diagram illustrating a configuration example of the wireless power transmission device 10 according to the present embodiment.

As illustrated in FIG. 3, the wireless power transmission device 10 includes a control unit 11, a monitoring unit 12, a transmission unit 13, and an antenna 14.

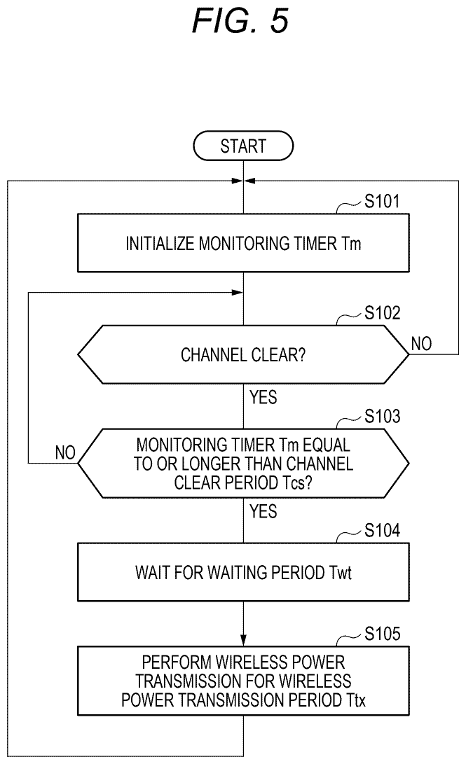

The control unit 11 performs processing for realizing functions of the wireless power transmission device 10. Details of the processing will be described later (see FIG. 5). The control unit 11 may be implemented by a processor, a controller, a central processing unit (CPU), a large scale integration (LSI), a field programmable gate array (FPGA), an application specific integrated circuit (ASIC), or the like. The control unit 11 may include a memory capable of storing data. The wireless power transmission device 10 may be configured with a software defined radio (SDR) or the like, and in this case, the control unit 11 may be implemented by software.

The monitoring unit 12 monitors the state of a channel through which wireless power transmission is to be performed. For example, the monitoring unit 12 monitors whether another radio wave is transmitted in the channel, and generates channel state information indicating the monitored result. The channel to be monitored may include, in addition to a channel through which wireless power transmission is to be performed, another channel that interferes with wireless power transmission. The monitoring unit 12 may provide the generated channel state information to the control unit 11. The other radio waves may be wireless power transmission transmitted by the other wireless power transmission device 10, wireless communication transmitted by the wireless communication system, or other radio waves.

Examples of a wireless system using a carrier of the 920 MHz band include a digital MCA relay station and a mobile station, an advanced MCA mobile station, a cellular phone (LTE) base station and a mobile station, RFID, and radio wave astronomy. Examples of the RFID include in-house radio (passive tag 1 W), specific low power (passive tag 250 mW), radio equipment for telemeter, telecontrol, and data transmission (active tag), and the like.

Examples of a wireless system using a carrier of the 2.4 GHz band include a wireless LAN system, a mobile object identification (a local wireless station or a specific low-power wireless station), an unmanned mobile object high-speed transmission system (a robot wireless system), a mobile satellite wireless system (N-STAR), a mobile satellite wireless system (a global star), a wireless station for a broadcasting organization (FPU), a radio wave astronomy, amateur radio, and the like.

Examples of a wireless system using a carrier of the 5.7 GHz band include a wireless LAN system, a dedicated short range communication (DSRC) system, an STL/TTL system for broadcasting business, an FPU/TSL system for broadcasting business, an unmanned mobile object high-speed transmission system (a robot wireless system), a weather radar, a radio wave astronomy, and amateur radio.

The transmission unit 13 performs wireless power transmission from the antenna 14 based on the determination or instruction of the control unit 11.

The antenna 14 transmits radio waves related to wireless power transmission to a space. Although FIG. 3 illustrates one antenna 14, a plurality of antennas 14 may be provided. When there are a plurality of antennas 14, the transmission unit 13 may perform wireless power transmission by beamforming or the like using the plurality of antennas 14.

Although the wireless power transmission device 10 illustrated in FIG. 2 is configured to perform wireless power transmission and carrier state monitoring by one antenna 14, the wireless power transmission device 10 may separately include the antenna 14 for wireless power transmission and an antenna for channel state monitoring.

At least some of the functions of the monitoring unit 12 and/or the transmission unit 13 may be included in the control unit 11, and at least some of the functions of the monitoring unit 12 may be included in the transmission unit 13.

### <Wireless Power Transmission Method>

FIG. 4 is a diagram illustrating state transitions related to the wireless power transmission method according to the present embodiment. In FIG. 4, a horizontal axis t indicates the passage of time. FIG. 5 is a flowchart illustrating an example of the wireless power transmission method according to the present embodiment. Next, processing related to the wireless power transmission method performed by the wireless power transmission device 10 will be described with reference to FIGS. 4 and 5.

The control unit 11 initializes a monitoring timer Tm (Tm=0) (S101). A value of the monitoring timer Tm increases with time.

The control unit 11 acquires the channel state information from the monitoring unit 12 and determines whether the channel for wireless power transmission is cleared (S102). The channel being cleared indicates a state in which other radio waves are not transmitted in the channel, and the channel not being cleared indicates a state in which other radio waves are transmitted in the channel.

When it is determined that the channel is not cleared (S102: NO), the control unit 11 returns the processing to step S101. That is, the monitoring timer Tm is not started, and the value of the monitoring timer Tm does not increase until the channel is cleared.

When it is determined that the channel is cleared (S102: YES), the control unit 11 determines whether the monitoring timer Tm is equal to or longer than a channel clear period Tcs (Tm≥Tcs) (S103).

When the monitoring timer Tm is less than the channel clear period Tcs (Tm<Tcs) (S103: NO), the control unit 11 returns the processing to step S102.

When the monitoring timer Tm is equal to or longer than the channel clear period Tcs (Tm≥Tcs) (S103: YES), the control unit 11 proceeds to the processing of the next step S104. That is, the control unit 11 does not proceed to the next step S104 until the state in which the channel is cleared continues for the channel clear period Tcs or longer. In addition, when transmission of the other radio wave is detected in the channel until the state in which the channel is cleared continues for the channel clear period Tcs or longer (that is, in a case where step S102 is NO), the control unit 11 returns the processing to step S101 and initializes the monitoring timer Tm.

In step S104, the control unit 11 waits for a waiting period Twt without starting wireless power transmission (S104). The control unit 11 may not acquire the channel state information from the monitoring unit 12 during the waiting period Twt. That is, the control unit 11 may not determine whether the channel is cleared in the waiting period Twt.

After waiting for the waiting period Twt, the control unit 11 instructs the transmission unit 13 to perform wireless power transmission for a wireless power transmission period Ttx (S105). The transmission unit 13 receives the instruction and wirelessly transmits power from the antenna 14 during the wireless power transmission period Ttx. Then, the process returns to step S101. While wireless power transmission is performed, the control unit 11 may not acquire the state information of the channel from the monitoring unit 12.

### <Operation Example>

Next, an operation example when each wireless power transmission device 10 performs the processing illustrated in FIG. 5 described above will be described.

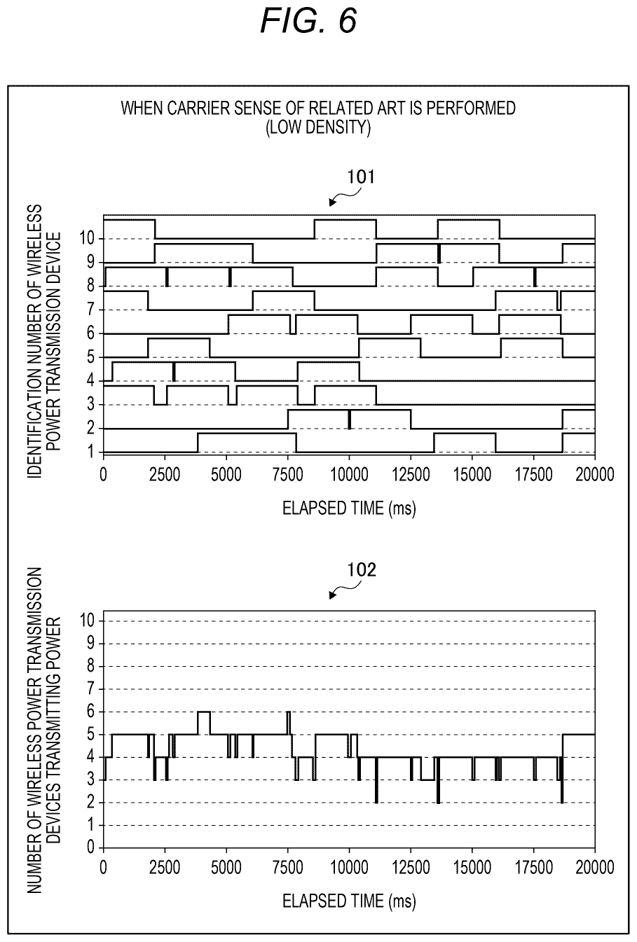

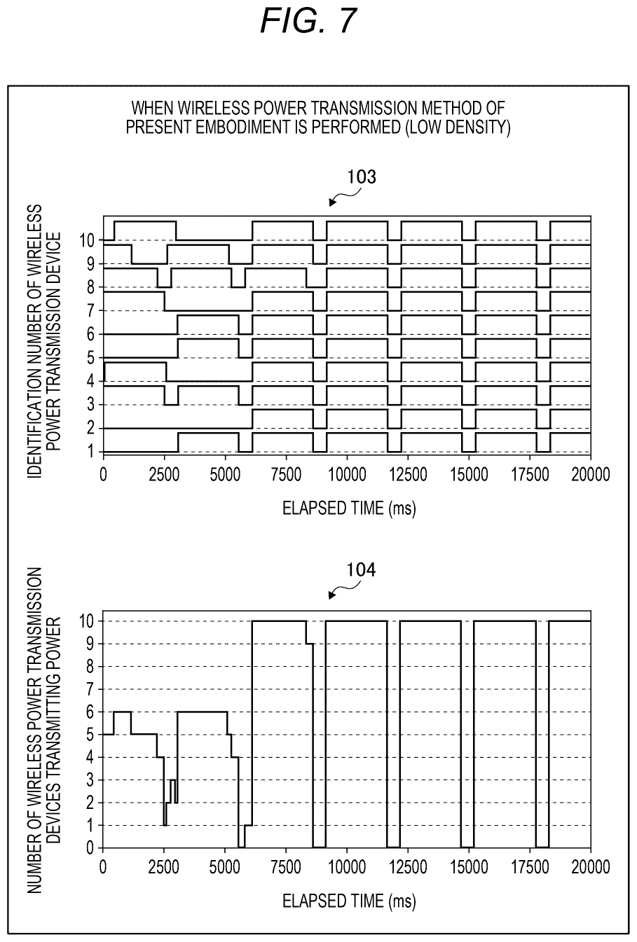

FIGS. 6 and 7 are diagrams illustrating an operation example in a wireless power supply system in which ten wireless power transmission devices are arranged at a low density. FIG. 6 illustrates an operation example of the wireless power supply system that performs the carrier sense of the related art. FIG. 7 illustrates an operation example of the wireless power supply system 1 that performs the wireless power transmission method of the present embodiment. The low density may be, for example, a density at which the ten wireless power transmission devices are distributed in an area of 10000 square meters.

In FIGS. 6 and 7, upper graphs 101 and 103 indicate periods during which the wireless power transmission devices perform wireless power transmission, numbers on a vertical axis indicate identification numbers of the wireless power transmission devices, and a horizontal axis indicate elapsed time (ms). Each graph line of the upper graphs 101 and 103 indicates whether the wireless power transmission device of the identification number is performing wireless power transmission, a period during which the graph line is above indicates a period during which wireless power transmission is performed, and a period during which the graph line is below indicates a period during which wireless power transmission is not performed.

In FIGS. 6 and 7, each of lower graphs 102 and 104 indicates the number of wireless power transmission devices performing wireless power transmission at each elapsed time, a vertical axis thereof indicates the number of wireless power transmission devices performing wireless power transmission, and a horizontal axis thereof indicates elapsed time (ms).

In the wireless power supply system that performs the carrier sense of the related art, as illustrated in the upper graph 101 of FIG. 6, wireless power transmission devices that are relatively distant from each other can perform wireless power transmission at the same time, but wireless power transmission devices that are relatively close to each other can only perform wireless power transmission to one of them due to the carrier sense. Therefore, as illustrated in the lower graph 102 of FIG. 6, two to four wireless power transmission devices always perform wireless power transmission, and no idle time occurs in the channel. Therefore, there is no room for the wireless communication system to perform wireless communication.

On the other hand, in the wireless power supply system 1 that performs the wireless power transmission method of the present embodiment, each wireless power transmission device 10 performs the processing illustrated in FIG. 5, so that a timing of (the channel clear period Tcs+the waiting period Twt) of each wireless power transmission devices 10 is synchronized and a timing of wireless power transmission is also synchronized as illustrated in the upper graph 103 of FIG. 7. Therefore, as illustrated in the upper graph 103 and the lower graph 104 of FIG. 7, an idle time occurs in the channel in the synchronized state (the channel clear time Tcs+the waiting period Twt). Note that (the channel clear period Tcs +the waiting period Twt) may be referred to as a non-transmission period. Therefore, the wireless communication system can perform wireless communication using the idle time of the channel.

As illustrated in the lower graph 104 of FIG. 7, in the wireless power transmission period Ttx, the ten wireless power transmission devices 10 simultaneously perform wireless power transmission. Therefore, the power supply efficiency is improved as compared with the wireless power supply system that performs the carrier sense of the related art.

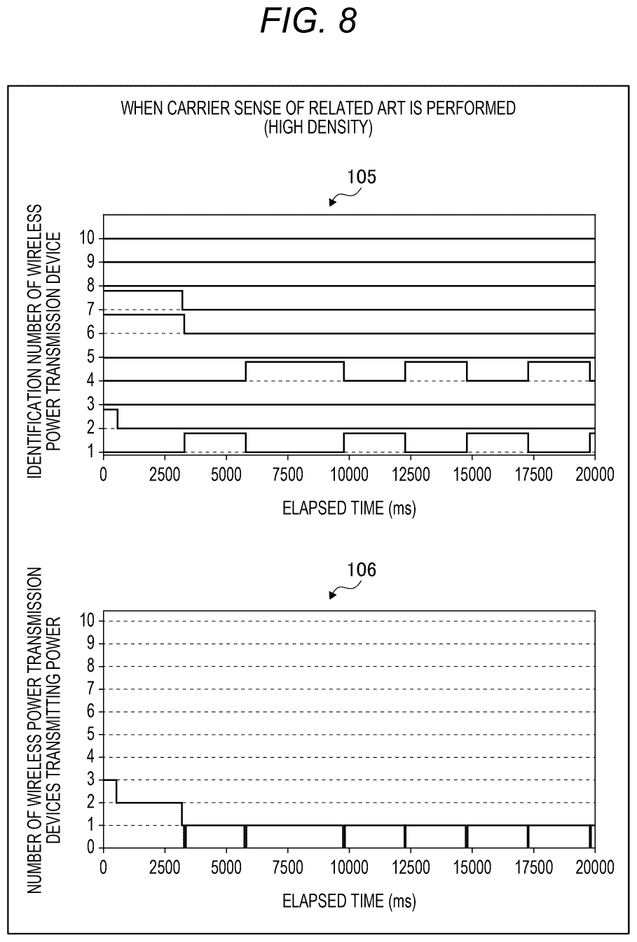

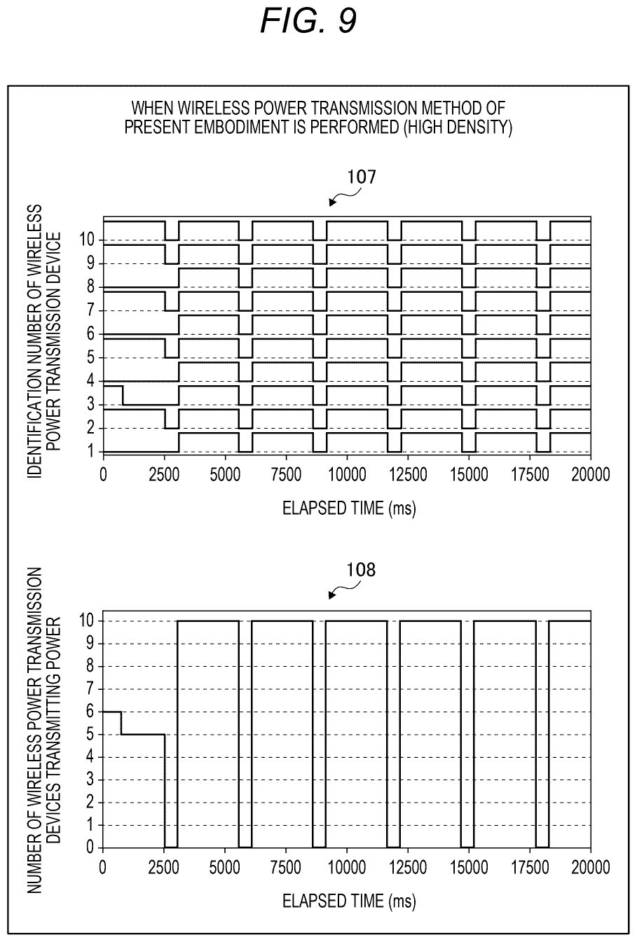

FIGS. 8 and 9 are diagrams illustrating an operation example of the wireless power supply system 1 in which ten wireless power transmission devices are arranged at a high density. FIG. 8 illustrates an operation example of the wireless power supply system that performs the carrier sense of the related art. FIG. 9 illustrates an operation example of the wireless power supply system 1 that performs the wireless power transmission method of the present embodiment. The high density may be, for example, a density at which the ten wireless power transmission devices are distributed in an area of 100 square meters.

Upper graphs 105 and 107 and lower graphs 106 and 108 illustrated in FIGS. 8 and 9 are viewed in the same manner as the upper graphs 101 and 103 and the lower graphs 102 and 104 illustrated in FIGS. 6 and 7. Accordingly, a description of the graph will be omitted here.

In the wireless power supply system that performs the carrier sense of the related art, as illustrated in the upper graph 105 of FIG. 8, a specific wireless power transmission device performs wireless power transmission, and the other wireless power transmission devices do not perform wireless power transmission by the carrier sense. Therefore, as illustrated in the lower graph 106 of FIG. 8, about one wireless power transmission device always performs wireless power transmission, and no idle time occurs in the carrier. Therefore, there is no room for the wireless communication system to perform wireless communication.

On the other hand, in the wireless power supply system 1 that performs the wireless power transmission method of the present embodiment, each wireless power transmission device 10 performs the processing illustrated in FIG. 5, so that (the channel clear period Tcs+the waiting period Twt) of each wireless power transmission devices 10 (that is, the non-transmission period) is synchronized and a timing of wireless power transmission is also synchronized as illustrated in the upper graph 107 of FIG. 9. Therefore, as illustrated in the upper graph 107 and the lower graph 108 of FIG. 9, an idle time occurs in the channel in the synchronized waiting period Twt. Therefore, the wireless communication system can perform wireless communication using the idle time of the channel.

As illustrated in the lower graph 108 of FIG. 9, in the wireless power transmission period Ttx, the ten wireless power transmission devices 10 simultaneously perform wireless power transmission. Therefore, the power supply efficiency is improved as compared with the wireless power supply system that performs the carrier sense of the related art.

According to the upper graph 101 of FIG. 6, since reception power values of the wireless power transmission devices having a relatively large separation distance are lower than a threshold value of the carrier sense, the wireless power transmission devices may perform wireless power transmission at the same time without recognizing each other's presence. This causes radio wave interference as in the hidden terminal problem in CSMA/CA. On the other hand, in the upper graph 103 of FIG. 7, although there are wireless power transmission devices 10 that cannot be directly recognized from each other, the wireless power transmission devices 10 can autonomously operate in synchronization with each other by repeating the relay.

As illustrated by the comparison between the upper graph 103 of FIG. 7 and the upper graph 107 of FIG. 9, in the wireless power supply system 1 in which the wireless power transmission devices 10 are arranged at a high density, the timing of wireless power transmission is synchronized in a shorter time than in the wireless power supply system 1 in which the wireless power transmission devices 10 are arranged at a low density. Therefore, the power supply efficiency is further improved.

### <Reason for Synchronization of Timing of Wireless Power Transmission>

As illustrated in FIGS. 4 and 5, when a period during which no other radio wave is transmitted continues for the channel clear period Tcs, each wireless power transmission device 10 waits for the waiting period Twt and starts wireless power transmission. The reason for providing the waiting period Twt is to absorb variations in the accuracy of the monitoring timer of each wireless power transmission device 10 and ensure the synchronization operation when there are two or more wireless power transmission devices 10. Hereinafter, a specific example will be described.

If the waiting period Twt is not provided, wireless power transmission is started immediately after the channel clear period Tcs continues. In this case, if there is a variation in accuracy such that the monitoring timer of the first wireless power transmission device counts a little faster than the monitoring timer of the second wireless power transmission device, the first wireless power transmission device starts wireless power transmission slightly earlier, and the second wireless power transmission device detects wireless power transmission transmitted by the first wireless power transmission device during channel clear monitoring, and cannot start wireless power transmission. Therefore, in the present embodiment, the occurrence of such a problem is avoided by providing the waiting period Twt. As a result, as illustrated in the graph of FIG. 7 or 9, a transmission start timing of each wireless power transmission device 10 is automatically synchronized, and the variation in the accuracy of the monitoring timer of each wireless power transmission device 10 is absorbed by the waiting period Twt, and as a result, the wireless power transmission period Ttx of each wireless power transmission device 10 can be synchronized.

The channel clear period Tcs may be a predetermined period. The channel clear period Tcs may be, for example, 500 ms or longer. The channel clear period Tcs may be read as a first period. The waiting period Twt may be a predetermined period. The waiting period Twt may be, for example, longer than 0 ms and 50 ms or less. The waiting period Twt may be read as a second period. The wireless power transmission period Ttx may be a predetermined period. The wireless power transmission period Ttx may be, for example, 2000 ms or longer and 2500 ms or less. The wireless power transmission period Ttx may be read as a third period. The predetermined channel clear period Tcs, the waiting period Twt, and the wireless power transmission period Ttx described above may be set in each wireless power transmission device 10. Accordingly, since the channel clear period Tos, the waiting period Twt, and the wireless power transmission period Ttx are set in common to the plurality of wireless power transmission devices 10, the waiting period Twt and the wireless power transmission period Ttx of the plurality of wireless power transmission devices 10 are synchronized as illustrated in FIG. 7 or FIG. 9.

The channel clear period Tcs may be longer than the waiting period Twt. This improves the probability of detecting the presence of the other wireless communication.

The wireless power transmission period Ttx may be longer than the channel clear period Tcs or the waiting period Twt. Accordingly, the wireless power transmission period Ttx is sufficiently secured, and the power supply efficiency is improved.

By receiving the wireless power transmission from the plurality of wireless power transmission devices 10, the wireless power reception device 20 can obtain larger power than the wireless power transmission from one wireless power transmission device 10. In the wireless power supply system 1 according to the present embodiment, as illustrated in FIG. 7 or FIG. 9, since the plurality of wireless power transmission devices 10 can perform wireless power transmission during a common period, the wireless power reception device 20 can obtain large power. Therefore, the power supply efficiency is improved.

### <Application Example of Wireless Power Supply System>

When using the 920 MHz band, the wireless power supply system 1 according to the present embodiment may be configured to operate by reducing the output of wireless power transmission of the wireless power transmission device 10 so as to be suitable for the specific low-power wireless station. Accordingly, it is not necessary to apply for and register a license related to wireless use, and the wireless power supply system 1 can be used in a wider variety of scenes. In the present embodiment, by monitoring the channel, the wireless power supply system 1 can be operated without affecting a wireless communication system to be preferentially used, such as a local wireless station. In addition, even when the output of the wireless power transmission of each wireless power transmission device 10 is reduced so as to be suitable for the specific low-power wireless station, in the wireless power supply system 1 according to the present embodiment, as illustrated in FIG. 7 or FIG. 8, since the plurality of wireless power transmission devices 10 can perform wireless power transmission in synchronization with each other, it is possible to realize a system in which the wireless power reception device 20 can obtain sufficient power.

For example, the wireless power supply system 1 without license according to the present embodiment may be applied to a logistics track. In this case, the wireless power supply system 1 may supply power to a sensor terminal or the like attached to a load carried by the truck, supply power to a vehicle interior accessory of the truck, and supply power to a sensor terminal or the like installed in a tire of the truck.

### Summary of Present Disclosure

The following techniques are disclosed based on the above description of the embodiment.

### <Technique 1>

According to the present disclosure, the wireless power transmission method for transmitting power by transmitting a radio wave to a space includes transmitting the radio wave to the space after waiting for the second period (for example, the waiting period Twt) when a state in which another radio wave is not transmitted in the space continues for at least the first period (for example, the channel clear period Tcs).

Accordingly, as illustrated in FIG. 7 or 9, the second period and a transmission timing of the radio wave are synchronized with each other, and thus it is possible to realize coexistence with wireless communication for transmitting or receiving data and improvement in power supply efficiency.

### <Technique 2>

In the wireless power transmission method according to Technique 1, the radio wave may be transmitted during the third period (for example, the wireless power transmission period Ttx).

Accordingly, as illustrated in FIG. 7 or FIG. 9, since the radio wave is transmitted in synchronization during the third period, the power supply efficiency is improved.

### <Technique 3>

In the wireless power transmission method according to Technique 2, the first period, the second period, and the third period may be predetermined periods.

Accordingly, the first period, the second period, and the third period are set in common to the plurality of wireless power transmission devices 10, and the second period and the third period can be synchronized as illustrated in FIG. 7 or FIG. 9.

### <Technique 4>

In the wireless power transmission method according to any one of Techniques 1 to 3, the first period may be longer than the second period.

Accordingly, balance between the first period and the second period can be appropriately set.

### <Technique 5>

In the wireless power transmission method according to Technique 4, the third period may be longer than the first period or the second period.

Accordingly, the third period during which the radio wave for power transmission is transmitted is sufficiently secured, and thus the power supply efficiency is improved.

### <Technique 6>

In the wireless power transmission method according to any one of Techniques 1 to 5, the radio wave and the other radio wave may be in a common frequency band.

Accordingly, it is possible to prevent the radio wave for power transmission and other radio wave from interfering with each other in the common frequency band.

### <Technique 7>

In the wireless power transmission method according to Technique 6, the frequency band may be a 920 MHz band, a 2.4 GHz band, or a 5.7 GHz band.

Accordingly, it is possible to prevent the radio wave for power transmission and other radio waves from interfering with each other in the common 920 MHz band, 2.4 GHz band, or 5.7 GHz band.

### <Technique 8>

The wireless power transmission device 10 according to the present disclosure that transmits power by transmitting a radio wave to a space includes the monitoring unit 12 configured to monitor whether another radio wave is transmitted in the space, the control unit 11 configured to determine transmission of the radio wave after waiting for the second period (for example, the waiting period Twt) when a state in which the other radio wave is not transmitted continues for at least the first period (for example, the channel clear period Tcs), and the transmission unit 13 configured to transmit the radio wave from the predetermined antenna 14 based on determination of the control unit.

Accordingly, as illustrated in FIG. 7 or 9, the second period and the transmission timing of the radio wave are synchronized with each other, and thus it is possible to realize coexistence with wireless communication for transmitting or receiving data and improvement in power supply efficiency.

Although the embodiment has been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, constituent elements in the embodiment described above may be freely combined without departing from the gist of the invention.

The present application is based on a Japanese Patent Application (Japanese Patent Application No. 2023-013126) filed on Jan. 31, 2023, and the contents thereof are incorporated herein by reference.

### INDUSTRIAL APPLICABILITY

The technique of the present disclosure is useful for a technique of transmitting power using radio waves.

### CROSS-REFERENCE TO RELATED APPLICATIONS

This is a continuation of International Application No. PCT/JP2023/042271 filed on Nov. 24, 2023, and claims priority from Japanese Patent Application No. 2023-013126 filed on Jan. 31, 2023, the entire content of which is incorporated herein by reference.

What is claimed is:

1. A wireless power transmission method for transmitting power by transmitting a radio wave to a space, the wireless power transmission method comprising
transmitting the radio wave to the space after waiting for a second period when a state in which another radio wave is not transmitted in the space continues for at least a first period.

2. The wireless power transmission method according to claim 1,
wherein the radio wave is transmitted during a third period.

3. The wireless power transmission method according to claim 2,
wherein the first period, the second period, and the third period are predetermined periods.

4. The wireless power transmission method according to claim 3,
wherein the first period is longer than the second period.

5. The wireless power transmission method according to claim 3,
wherein the third period is longer than the first period or the second period.

6. The wireless power transmission method according to claim 1,
wherein the radio wave and the other radio wave are in a common frequency band.

7. The wireless power transmission method according to claim 6,
wherein the frequency band is a 920 MHz band, a 2.4 GHz band, or a 5.7 GHz band.

8. A wireless power transmission device that transmits power by transmitting a radio wave to a space, the wireless power transmission device comprising:
a monitoring unit that monitors whether another radio wave is transmitted in the space;
a control unit that determines transmission of the radio wave after waiting for a second period when a state in which the other radio wave is not transmitted continues for at least a first period; and
a transmission unit that transmits the radio wave from a predetermined antenna based on determination of the control unit.
